(19) United States
(12) Patent Application Publication
(10) Pub. No.: US 2003/0101127 A1
(43) Pub. Date: May 29, 2003

(54) Network-based system for the management of construction bids

(76) Inventor: Michael Anfred Cornelius, Encinitas, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/995,366

(22) Filed: Nov. 27, 2001

Related U.S. Application Data
(60) Provisional application No. 60/250,333, filed on Nov. 30, 2000.

(51) Int. Cl. G06F 17/60

(52) U.S. Cl. 705/37

(57) ABSTRACT

The present invention provides an Internet-based construction bid management system that can be accessed and utilized by construction project owners, general contractors, subcontractors, vendors, and other parties interested in the construction bidding process. The system accommodates the posting of projects, the submission of bids, the distribution of construction drawings, and the collection of historical bid results, via any number of networked computer devices. The automated nature of the system ensures that the current bid status of any number of projects can be quickly updated for immediate access by the various participants

### RELATED APPLICATION

This application claims priority from U.S. Provisional Application Serial No. 60/250,333, filed Nov. 30, 2000, titled “Network-Based System for the Management of Construction Bids.”

### FIELD OF THE INVENTION

The present invention relates generally to bidding procedures related to construction contracts. More particularly, the present invention relates to a computerized, network-based system that facilitates the efficient management of project information, bid solicitations, bid submissions and bid results.

### BACKGROUND OF THE INVENTION

Public and private construction projects are usually awarded following a bidding process where a number of general contractors submit proposals to the project owner and the project owner selects a general contractor based on the bids. In preparing a project bid, a general contractor will solicit a number of subcontractor bids and/or supplier bids related to various aspects of the project, e.g., foundation work, electrical work, structural engineering, or the like. In addition, subcontractors will solicit supplier bids. Project information and bid solicitations are usually contained in one or more static trade publications distributed to project owners, general contractors, subcontractors, service providers, architects, suppliers, engineers, and other interested parties.

Such trade publications (commonly referred to as “bid sheets”) can be prohibitively expensive for relatively small businesses and limited in scope to certain regions or states. In addition, the information contained in such trade publications may be relatively limited. For example, some listings may only provide project names, contact names, and contact telephone numbers. In a typical scenario, a general contractor or a subcontractor reviews the bid sheets to identify those projects that may be of interest. Then, the contractor may request additional information from another party via the telephone, standard mail, or facsimile, where such additional information is required for purposes of making a bidding decision. Indeed, the contractor may spend a considerable amount of time only to discover that the project is not suitable for bidding.

Traditional procedures for soliciting construction bids, collecting information pertinent to the calculation of a bid, and entering bids can be terribly inefficient and time consuming. For example, an electrical subcontractor may only be interested in projects that require electrical work while a general contractor may be particularly focused on soliciting bids from minority-owned business enterprises or women-owned business enterprises (MBE/WBE). The limited amount of information contained in bid sheets may not be sufficient to enable such parties to quickly eliminate irrelevant projects. In addition, when calculating a bid, a contractor typically requests plans and specifications from the project owner; conventional delivery of such documentation can be expensive and time consuming. Furthermore, large or complex projects can involve a large number of contractors, subcontractors, vendors, service suppliers, and other entities. Conventional bidding procedures make it very difficult to manage communications between the various interested parties, difficult to organize the large number of submitted proposals, and difficult to efficiently provide updated project information to a large number of interested parties in a short timeframe.

### BRIEF SUMMARY OF THE INVENTION

The preferred embodiment of the present invention is an Internet-based system that may be accessed by project owners, general contractors, subcontractors, service providers, vendors, and other parties interested in various aspects of the construction bidding process. The system is centered around an Internet web site that serves as the focal point for the posting of projects, bid solicitations, and bid submissions. The system facilitates communication between participants in the bidding process, searching of project information, locating suitable contractors, delivering of project specifications and plans, posting of bid results, and providing historical data related to past project bids.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a schematic representation a network-based bid management system according to the present invention;

FIG. 2 is an example display screen showing the project information for a sample engineering project;

FIG. 3 is an example display screen showing a typical bid intents listing; and

FIG. 4 is an example display screen showing a listing of projects and a search criteria entry area.

### DETAILED DESCRIPTION OF A PREFERRED EMBODIMENT

The present invention may he described herein in terms of functional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the network system described herein is merely one exemplary application for the invention.

It should be appreciated that the particular implementations shown and described herein are illustrative of the invention and its best mode and are not intended to otherwise limit the scope of the invention in any way. Indeed, for the sake of brevity, conventional techniques for signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

General System Environment

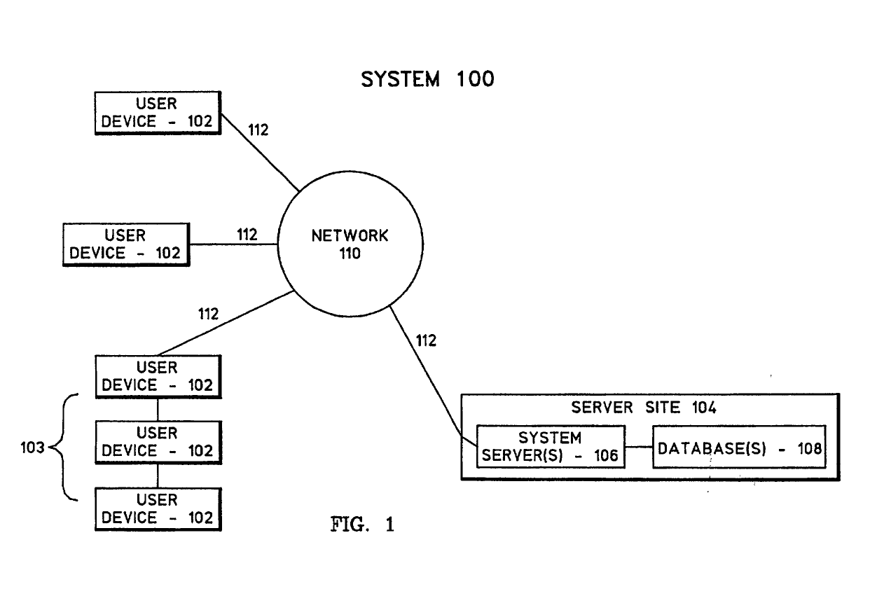

FIG. 1 is a schematic representation of a bid management system 100 in which the techniques of the present invention may be implemented. System 100 is suitably configured to provide a centralized and server-driven depository for construction project descriptions, bid solicitations, bid proposals, and other information relevant to any number of construction projects. System 100 is depicted in a generalized manner to reflect its flexible nature and ability to cooperate with any number of different communication systems, service providers, and user devices. System 100 may include any number of user devices 102, each preferably having an associated display element, that communicate with at least one service site 104. Service site 104 preferably includes a number of servers 106 configured to support the features and functionality described herein and at least one database 108 in communication with servers 106. In the context of a practical implementation, service site 104 may include a firewall server, a web server, a file transfer protocol (FTP) server, a simple mail transfer protocol (SMTP) server, and other suitably configured servers. Although depicted as though servers 106 are commonly located, bid management system 100 may utilize a distributed server architecture in which a number of servers 106 communicate and operate with one another even though physically located in different locations.

As used herein, a “server” refers to a computing device or system configured to perform any number of functions and operations associated with bid management system 100. Alternatively, a “server” may refer to software that performs the processes, methods, and/or techniques described herein. From a hardware perspective, system 100 may utilize any number of commercially available servers, e.g., the IBM AS/400, the IBM RS/6000, the SUN ENTERPRISE 5500, the COMPAQ PROLIANT ML570, and those available from UNISYS, DELL, HEWLETT-PACKARD, or the like. Such servers may run any suitable operating system such as UNIX, LINUX, or WINDOWS, and may employ any suitable number of microprocessor devices, e.g., the PENTIUM family of processors by INTEL or the processor devices commercially available from ADVANCED MICRO DEVICES, IBM, SUN MICROSYSTEMS, or MOTOROLA.

The server processors communicate with system memory (e.g., a suitable amount of random access memory), and an appropriate amount of storage or “permanent” memory. The permanent memory may include one or more hard disks, floppy disks, CD-ROM, DVD-ROM, magnetic tape, removable media, solid state memory devices, or combinations thereof. In accordance with known techniques, the operating system programs and any server application programs reside in the permanent memory and portions thereof may be loaded into the system memory during operation. In accordance with the practices of persons skilled in the art of computer programming, the present invention is described below with reference to symbolic representations of operations that may be performed by one or more servers associated with bid management system 100. Such operations are sometimes referred to as being computer-executed. It will be appreciated that operations that are symbolically represented include the manipulation by the various microprocessor devices of electrical signals representing data bits at memory locations in the system memory, as well as other processing of signals. The memory locations where data bits are maintained are physical locations that have particular electrical, magnetic, optical, or organic properties corresponding to the data bits.

When implemented in software, various elements of the present invention are essentially the code segments that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

As used herein, a “user device” is any device or combination of devices capable of providing system information to an end user of bid management system 100. For example, a user device 102 may be a personal computer, a television monitor, an Internet-ready console, a wireless telephone, a personal digital assistant (PDA), a home appliance, a component in an automobile, or the like. User devices 102 are preferably configured in conventional ways known to those skilled in the art. In addition, user devices 102 may be suitably configured to function in accordance with certain aspects of the present invention, as described in more detail herein. For the sake of clarity and brevity, conventional and well-known aspects of user devices 102 are not described in detail herein.

In the preferred embodiment, bid management system 100 is capable of supporting a plurality of different user devices 102 in a simultaneous manner. In practice, a single end user may utilize a plurality of user devices 102 in conjunction with system 100. For example, a person may use a desktop computer at the office, a portable laptop computer while traveling, a cellular telephone, and a PDA. System 100 is capable of supporting the integrated use of such multiple devices in a manner that enables the user to access service site 104 and utilize the features of the present invention via the different user devices 102. In addition, system 100 is preferably configured to support a plurality of end users, each of which may have personal data or individual preferences and display settings associated therewith. Such user-specific characteristics may be suitably stored in database 108 and managed by system 100.

In accordance with one preferred embodiment, user devices 102 communicate with service site 104 via a network 110, e.g., a local area network (LAN) a wide area network (WAN), or the Internet. In addition, one or more user devices 102 can be arranged as a LAN or a WAN (as identified by reference number 103). In the preferred embodiment, network 110 is the Internet and each of the individual user devices 102 is configured to establish connectivity with the Internet using conventional application programs and conventional data communication protocols. For example, each user device 102 preferably includes a web browser application such as NETSCAPE NAVIGATOR or INTERNET EXPLORER and each user device 102 may be connected to the Internet via an internet service provider (ISP) (not shown in FIG. 1). In a practical embodiment, user devices 102 and service site 104 are connected to network 110 through various communication links 112. As used herein, a “communication link” may refer to the medium or channel of communication, in addition to the protocol used to carry out communication over the link. In general, a communication link may include, but is not limited to, a telephone line, a modem connection, an Internet connection, an Integrated Services Digital Network (ISDN) connection, an Asynchronous Transfer Mode (ATM) connection, a frame relay connection, an Ethernet connection, a coaxial connection, a fiber optic connection, satellite connections (e.g., Digital Satellite Services), wireless connections, radio frequency (RF) connections, electromagnetic links, two-way paging connections, and combinations thereof.

Communication links 112 may be suitably configured in accordance with the particular communication technologies and/or data transmission protocols associated with the given user device 102. For example, a communication link 112 may utilize broadband data transmission techniques, the TCP/IP suite of protocols, the wireless application protocol (WAP), hypertext markup language (HTML), extensible markup language (XML), or a combination thereof. Communication links 112 may be established for continuous communication and data updating or for intermittent communication, depending upon the infrastructure.

As mentioned above, system servers 106 preferably communicate with one or more databases 108. A given database 108 may be maintained at service site 104 or maintained by a third party external to the overall architecture of bid management system 100. Database 108 is preferably configured to communicate with system servers 106 in accordance with known techniques such as the TCP/IP suite of protocols. In a practical embodiment, database 108 may be realized as a conventional SQL database, e.g., an ORACLE-based database.

The databases 108 preferably contain some or all of the following data (without limitation): construction project descriptions; end user profiles; project specifications/plans; bidding information; end user preferences; and any other information necessary to carry out the techniques of the present invention as described herein. The end user profiles may include names, email addresses, account information, and mailing addresses.

System Features

The network-based architecture of bid management system 100 provides a number of efficient and effective features to the end users. Briefly, bid management system 100 is preferably configured to: (1) receive new project information directly from owners and provide immediate online access to such information; (2) efficiently search for project information based on searching criteria specified by end users; (3) facilitate the electronic posting and/or downloading of project specifications and plans; (4) display a substantially continuous and real-time listing of those end users who have expressed an intent to bid on projects; (5) provide an online question and answer forum for the rapid exchange of information between project owners and other end users; (6) facilitate secure communication (e.g., bids) between contractors, subcontractors, and suppliers; and (7) display a summary of projects for which an end user has submitted bids.

In accordance with the exemplary Internet-based embodiment, a suitably configured web site is maintained at service site 104. End users connected to the Internet access the web site by its uniform resource locator (URL), an associated hyperlink, a shortcut, or the like. For example, the web site may be associated with one or more domain names such as ebidboard.com. As described briefly above, system servers 106 preferably include a web server, which may be configured in a conventional manner to provide web navigation capabilities in connection with the Internet. In a practical embodiment, the web server may employ commercially available applications such as APACHE, MICROSOFT IIS, NETSCAPE, or the like. The web server may operate to manage, process, and deliver HTML documents (such as web pages and formatted data) in response to requests from the various user devices 102.

In one practical embodiment, end users must be authorized to access bid management system 100. In this respect, the service provider may enter into subscription fee arrangements with the users of system 100 and assign user names, passwords, encryption keys, or take any number of security measures to maintain the integrity of the bid management system 100.

User Registration

Although not a requirement of the present invention, bid management system 100 is preferably designed to accommodate typical end users found in a construction bid community. For example, bid management system is particularly suitable for use by the following types of end users: governmental and private owners (i.e., individuals and entities that require construction services); design professionals; contractors, subcontractors, suppliers and service providers; minority-owned, woman-owned, or disadvantaged business enterprises (MBEWBEs); equipment manufacturers, leasing companies, and rental companies; and construction employers and prospective construction employees. These types of end users can be very active in the bidding process for public or private construction projects.

Each end user registers with the bid management system 100 in a suitable manner. In the preferred embodiment, user registration is performed online via the respective user device 102. The web site maintained by service site 104 preferably allows an end user to register in an interactive manner by traversing through various web pages generated by system servers 106. In the preferred embodiment, the end user selects a general category related to his current role. Bid management system 100 is configured to provide a number of the following options (this list is merely indicative of exemplary categories and is not intended to limit the scope of the invention in any way): owner, architect, construction manager, structural engineer, civil engineer, geotechnical engineer, electrical engineer, mechanical engineer, general contractor, subcontractor, supplier/vendor, insurance/bonding, and service provider. In addition to this field, the end user may be prompted to enter some basic identifying information such as: company name, division or department, contact person name, mailing address, telephone number, fax number, email address, web page URL, username, and password.

In accordance with one aspect of the present invention, an end user can enter additional information in his member profile; such additional information allows the bid management system to conduct more intelligent searching and sorting. Depending upon the end user's designated category, bid management system 100 may prompt the end user to complete data fields that are specifically related to that category. For example, an end user can enter data related to his state and local licenses and bonding status, his MBEWBE certifications, and his area of work. The end user's designated area of work can be entered in text format (e.g., a descriptive passage or a number of keywords) and/or by using alphanumerical codes that represent specific areas of expertise. For example, typical keyword designations are: site construction, concrete, masonry, metals, wood and plastics, thermal and moisture protection, doors and windows, finishes, mechanical, and electrical. The preferred embodiment utilizes standardized Construction Specifications Institute (CSI) codes, e.g., 02100=site remediation, 02300=earth work, 02500=utility service, and 02900=planting. These keywords and CSI codes are merely examples; a practical embodiment can utilize any number of words, phrases, and codes.

Bid management system 100 maintains the various user profiles in database 108 such that system servers 106 can access the profiles as necessary to support the various features of system 100. System 100 allows an end user to modify or update his respective user profile as necessary; database 108 is suitably updated to reflect any changes to the profile.

Project Submission

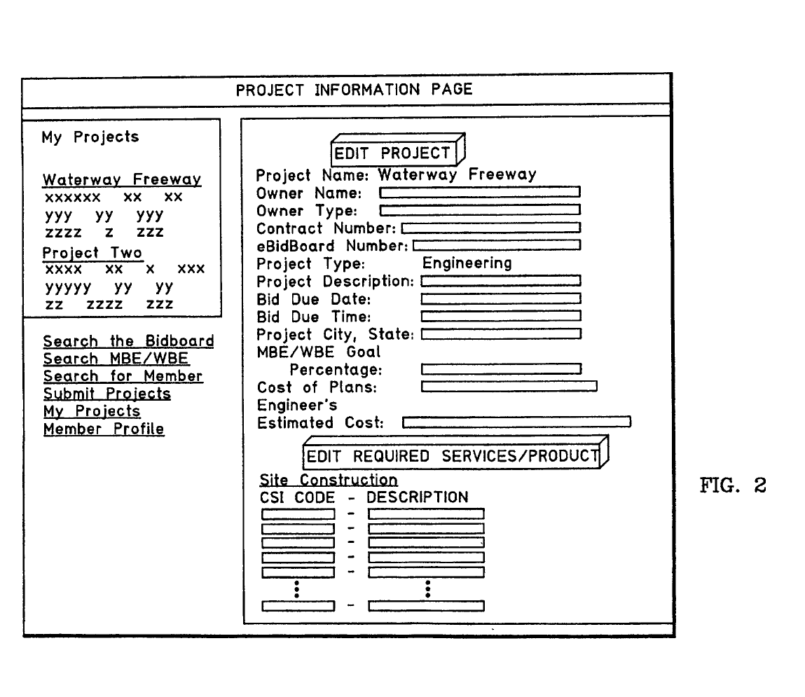

Once a project owner is registered with bid management system 100, it may submit any number of projects for posting on the system web site When posted, the project information can be viewed by other registered end users (general contractors, subcontractors, etc.), and any number of those end users can submit bids in response to the posting. In response to a project submission request, bid management system 100 obtains project information from the owner. Although the specific type of information may vary from system to system, typical project information provided by the end user includes: project name, owner name, contract number, a short description of the project, the bid date and time, the project location, and the estimated cost. The project information may also include the end user's registration number, whether the owner is a public or private entity, the project type, the MBEWBE goal percentage, the cost of plans/specifications, and the applicable CSI codes for the project. FIG. 2 is an example display screen showing the summary project information for a sample engineering project.

The preferred embodiment of the present invention is configured to facilitate the uploading, storage, downloading, transmission, organization, and management of electronic documents related to the projects and/or other files or data associated with the bidding procedure or the operation of bid management system 100. For example, when submitting a new project, the project owner may be asked whether it will make electronic plans or specifications available to end users via bid management system 100. If so, then the project owner can upload (or otherwise transfer) such plans or specifications to system 100 via network 110. In a practical embodiment, the uploaded documents may be formatted, configured, and transmitted in accordance with any number of known techniques. For example, system 100 may utilize FTP or email delivery of PDF, TIF, GIF, DOC, PPT, and other document formats. Such electronic delivery eliminates labor costs and time delays associated with conventional paper delivery.

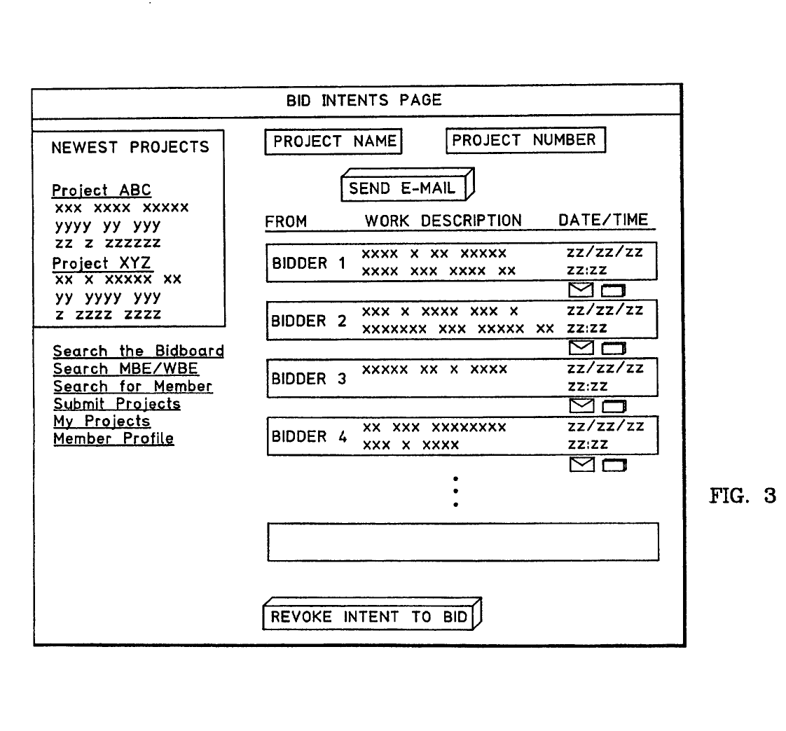

Bid management system 100 allows an owner to conveniently view all of its submitted projects by name, bid due date, estimated cost, or other parameters. In the preferred embodiment, the project names are displayed as active links such that an end user can easily select any given project to view additional information related to that project. The system 100 may provide a number of tabbed categories of information related to each project, e.g., a summary of the project details, the owner team members, documents or specifications available to bidders, a list of intended bidders, and a question and answer forum (see FIG. 3).

Project Matching and End User Notification

Bid management system 100 is preferably configured to match submitted projects with end users who may have an interest in bidding on the projects. For example, system 100 may employ a suitable search algorithm that identifies CSI codes contained in a submitted project and searches for end users having the same (or related) CSI codes listed in their end user profiles. In addition, system 100 may utilize a text searching algorithm that identifies keywords related to the type or scope of the submitted project and searches for end users associated with the same (or similar) descriptive terms. For example, if a project involves a specific concrete foundation task, then system 100 can identify any number of end users that perform concrete foundation work.

In accordance with a preferred aspect of the present invention, bid management system 100 notifies end users in response to the project matching results. In this manner, end users can be notified of particularly relevant projects as they are submitted without having to routinely review conventional bid sheets and/or the web site maintained by system 100. The system 100 (or administrators of system 100) can notify end users via email, facsimile, telephone communications, regular mail, web site postings, or the like. An electronic notification (e.g., by email) may include an active link to the specific project, thus making it very convenient for an end user to quickly view the details of the project.

Bid Intent Submission

The bid management system 100 allows end users to search and locate desirable projects in an electronic manner. If an end user finds a suitable project, he can post an intent to bid on that project by “clicking” on a suitable active icon or hyperlink. In response to this action, the bid management system 100 places that end user into the pool of interested bidders for that project. In addition, system 100 may generate a confirmation email for delivery to the end user, the project owner, and/or other interested bidders. When an end user posts an intent to bid on a project, system 100 includes that project on the end user's “my bid intents” list. In this manner, each end user can quickly and easily view all of the projects for which an intent to bid has been posted. In addition, posting an intent to bid allows the end user to view a listing of all other parties who intend to bid on the same project. This listing of the pool of intended bidders can include information regarding each intended bidder, such as the name, date and time of the intent to bid posting, a work description, contact information, and an active icon or hyperlink leading to more detailed information. The system allows end users within a given project pool to securely communicate with each other regarding project scope issues and other matters relevant to the bidding process. FIG. 3 is an exemplary display screen of a typical bid intents listing.

In a practical embodiment, a request for plans and specifications is included in the submission of an intent to bid. Depending upon the electronic delivery capabilities of the project owner and/or the requesting end user, bid management system 100 may transmit the plans electronically or in a conventional manner (regular mail, fax, hand delivery, etc.).

An end user may revoke an intent to bid prior to the bidding date. In the preferred embodiment, bid management system 100 provides an active icon or link that revokes an intent to bid when selected by the end user. As described above in connection with the posting of an intent to bid, the system 100 may generate an email notification to the end user, the project owner, and/or any of the other pool participants in response to a revocation. In addition, the system 100 will remove the name of the revoking party from the bid intents list.

Processing of Bid Results

Bid management system 100 can be configured to provide bid results to the end users. For example, if the opening and awarding of bids is conducted in a public location, then audio/visual equipment can be deployed at the location to provide information to the end users via network 110. System 100 may utilize any number of known techniques to transmit such audio/visual data in a real-time or delayed manner. Alternatively, system 100 can broadcast (via email, messaging, facsimile, etc.) bid results to interested parties once such results are made public. In addition, the system web site can be employed to post the bid results for remote viewing by the end users. The system 100 may restrict access to bid results information in accordance with any suitable criteria For example, system 100 may only provide access to those end users in the bidding pool for the respective project. The bid results information may identify the winning bidder, the bid amount, the names of subcontractors included in the bid, and other information relevant to the winning bid or the winning bidder.

Bid management system 100 may also maintain historical data (e.g., in database 108) associated with past bids. In a practical embodiment, an end user may be permitted to search such historical data for purposes of research, to investigate bidding trends, and to better assess the competitive environment. The historical data can be searched according to any number of designated fields, e.g., type of project, name of winning bidder, bid amount, CSI codes, project location, and the like. In this respect, such historical bid data can foster better and more efficient construction bids.

Searching Capabilities

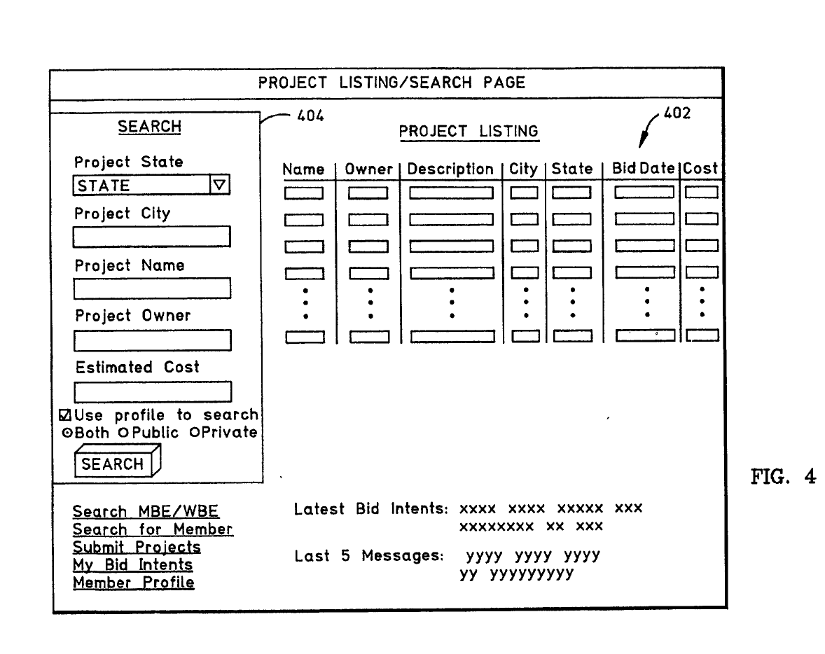

Bid management system 100 is configured to allow end users to electronically search the database 108 for projects, members, documents, and/or other information relevant to the bidding procedure. For example, system 100 provides a search engine that searches projects according to one or more of the following criteria: project state; project city; project name; project owner; estimated cost; and whether the contract is public or private. In this respect, an end user can perform a narrowly focused search by entering multiple search criteria. FIG. 4 is an example display screen showing a listing of projects 402 and a search criteria entry area 404.

In the preferred embodiment, an end user can search for projects according to his member profile. System 100 may utilize any of the fields associated with the end user's registration, such as: address; zip code; area code; state; city; MBEWBE status; description of work; CSI codes, and the like. Such profile searching is a powerful tool that enables the end users to quickly locate projects that are specifically related to his field of expertise and/or his geographical location.

End users of bid management system 100 can search for other end users that match any number of searching criteria. For example, membership rosters can be searched according to any of the following criteria: name or company name; city or state of residence/operation; fields of specialty; CSI codes, or the like. In addition, bid management system 100 is preferably configured to search its membership roster according to MBEWBE status. As described above, MBEWBE status can be important in the context of public contracts having specific MBEWBE participation goals. Thus, system 100 allows end users to specifically target MBEWBE end users in a convenient and efficient manner. The preferred embodiment allows end users to search the membership records according to any number of the following additional criteria: MBEWBE status; certifying agency; and other details relating to MBEWBE certification or status.

Efficient Communication

The network-based configuration of bid management system 100 facilitates efficient and effective communication between project owners, contractors, subcontractors, and other end users prior to the actual bid date. For example, system 100 can automatically generate email notifications related to new project submissions, posted bid intents, revoked bid intents, questions and answers related to posted projects, or the like. System 100 can deliver electronic documents via email, direct download, FTP, or the like, whether such documents are stored at service site 104 or maintained by the project owners. Furthermore, system 100 can be employed in conjunction with any number of conventional procedures such as regular mail or fax delivery of notices or documents, interactive voice response systems, telephone inquiries, or the like.

Bid management system 100 may generate periodic updates and reports related to the status of submitted projects. Such reports can be posted for online access by the end users, or sent to the end users via email, facsimile, regular mail, hand delivery, or the like. The reports can contain any data or information related to the project status or the bidding process. For example, system 100 may email to all end users in a given bid intent pool a current bid intents list that reflects those end users who have posted an intent to bid. As described in more detail above, the bid intents list for a given project may increase or decrease over time; the bid intents report generated and distributed by system 100 allows the interested parties to monitor the competitive landscape as it changes from day to day. System 100 may also email submitted questions (and responsive answers) to members of each bid intents list such that all of the interested parties are kept fully informed as the bidding process progresses.

Bid management system 100 also facilitates the secure submission of subcontractor bids to general contractors. For example, a subcontractor can quickly submit a bid to a general contractor via the email features of system 100. Referring to FIG. 3, a subcontractor can select a plurality of general contractors (each of whom are bidding on the same project) and easily transmit a common bid via an email. Of course, the system 100 can be configured to protect the integrity of the bidding process by keeping each individual email confidential. In this manner, a subcontractor need not waste time communicating with each individual general contractor on a personal basis.

Bid management system 100 may also be configured to support targeted advertising on its web site. For example, system 100 preferably enables construction equipment manufacturers, service suppliers, leasing and rental companies, end users (e.g., subcontractors), and/or other entities to advertise in a project-specific manner. Thus, a provider of trenching equipment can focus advertising in connection with those projects that require trenching. System 100 may utilize appropriate search engines and/or matching algorithms to determine how best to match advertisers to submitted projects. As described above in connection with the end user notification feature of system 100, this targeted advertising approach may utilize CSI codes and/or descriptive text entries as a matching tool.

In summary, the deployment of system 100 makes the construction design, bid, and building process more efficient and cost effective. System 100 brings owners, design professionals, contractors, subcontractors, suppliers, and service providers together in an interactive and substantially real-time manner for collaboration and dissemination of information relating to the design, bidding, and building of current and future construction projects.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as set forth in the following claims.

What is claimed is:

1. A method for the management of construction bids, said method comprising:
receiving descriptive information related to a construction project;
electronically posting at least a portion of said descriptive information for viewing by a number of potential bidders;
maintaining a list of parties having an intent to bid on said construction project; and
updating a bidding status of said construction project to reflect participation by interested parties.

2. A system for the management of construction bids, said system comprising:
at least one server configured to communicate with at least one networked user device; and
at least one database connected to said at least one server, said at least one database being configured to store descriptive information related to a construction project;
said at least one server being further configured to:
electronically post at least a portion of said descriptive information for viewing by a number of potential bidders;
maintain a list of parties having an intent to bid on said construction project; and
update a bidding status of said construction project to reflect participation by interested parties.

3. A method for the management of construction bids, said method comprising:
receiving, via a computer network, descriptive information related to a construction project;
providing network access to at least a portion of said descriptive information; and
facilitating the communication of bids for said construction project between interested parties, via said computer network.
